(19) United States
(12) Patent Application Publication
(10) Pub. No.: US 2004/0244871 A1
(43) Pub. Date: Dec. 9, 2004

(54) Method for forming a colored red oak product

(76) Inventor: Min-Ju Chung, Taichung Hsien (TW)

Correspondence Address: WHYTE HIRSCHBOECK DUDEK S C, 555 EAST WELLS STREET, SUITE 1900, MILWAUKEE, WI, 53202, US

(21) Appl. No.: 10/454,150

(22) Filed: Jun. 4, 2003

(51) Int. Cl. B27M 1/00; B27K 1/00

(52) U.S. Cl. 144/364; 144/380

(57) ABSTRACT

A method for forming a colored red oak product includes the steps of: (a) processing a red oak substrate to form a red oak product; (b) soaking the red oak product in a bleaching agent so as to bleach surfaces of the red oak product; (c) drying the red oak product after the step (b); and (d) dyeing the red oak product in a coloring agent after the step (c).

### BACKGROUND OF THE INVENTION

1. Field of the Invention

The invention relates to a method for forming a colored wood product, more particularly to a method for forming a colored red oak product.

2. Description of the Related Art

Red oak is widely used in the field of furniture products due to the aesthetic grain thereof. The red oak is usually used to make various wood products, such as a baluster, an armrest, a stair tread, a fitting, a newel post, or the like.

However, the red oak usually has two problems which may negatively affect the appearance of the product made therefrom. One is the “black mineral streak” typical of the red oak product, and the other is a relatively large color variation among the grains of the red oak product. There are about 20% to 30% of the red oak products having the problem of the black mineral streak. The black mineral streaks usually appear on the surfaces of the red oak products after further processing. Therefore, the red oak products having the aforesaid problems should be discarded, which in turn results in waste of red oak resources, and which may increase the production costs as well.

Additionally, it is highly desired in the art to change the color of the red oak product according to the specific requirement of the customer.

### SUMMARY OF THE INVENTION

Therefore, the object of the present invention is to provide a method for forming a colored red oak product, which can overcome the aforesaid shortcomings of the prior art, and which can provide the red oak product with a desirable color according to the requirement of the customer.

In one aspect, the present invention provides a method for forming a colored red oak product, comprising the steps of: (a) processing a red oak substrate to form a red oak product; (b) soaking the red oak product in a bleaching agent so as to bleach surfaces of the red oak product; (c) drying the red oak product after the step (b); and (d) dyeing the red oak product in a coloring agent after the step (c).

In another aspect, the present invention provides a method for forming a colored wood product, comprising the steps of: (a) processing a wood substrate to form a wood product; (b) soaking the wood product in a bleaching agent so as to bleach surfaces of the wood product; (c) drying the wood product after the step (b); and (d) dyeing the wood product in a coloring agent after the step (c); wherein the wood product is one selected from the group consisting of a baluster, an armrest, a stair tread, a fitting, and a newel post.

### BRIEF DESCRIPTION OF THE DRAWING

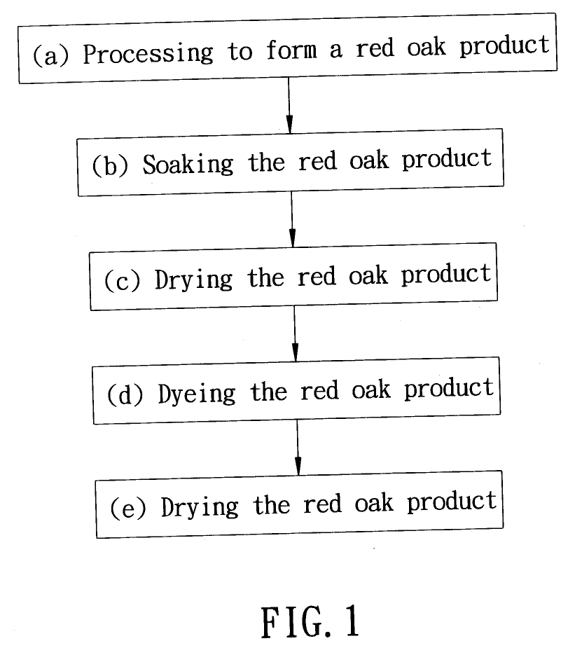

Other features and advantages of the present invention will become apparent in the following detailed description of the preferred embodiment with reference to FIG. 1, which is a flow diagram of a preferred embodiment of the method for forming a colored red oak product according to this invention.

### DETAILED DESCRIPTION OF THE PREFERRED EMBODIMENTS

Referring to FIG. 1, the preferred embodiment of the method for forming a colored red oak product according to this invention includes:

(a) processing a red oak substrate to form a red oak product;

(b) soaking the red oak product in a bleaching agent so as to bleach surfaces of the red oak product;

(c) drying the red oak product after the step (b);

(d) dyeing the red oak product in a coloring agent after the step (c); and

(e) drying the red oak product after the step (d)

In the step (a), the red oak product which is produced by processing, such as by cutting and shaping, the red oak substrate, such as a unitary red oak block or a unitary red oak board, includes a baluster, an armrest, a stair tread, a fitting, a newel post, or the like.

In the step (b), the bleaching agent useful in the preferred embodiment of the method according to this invention is an aqueous hydrogen peroxide solution in the presence of an alkaline solution.

Hydrogen peroxide is stable in the presence of an acid. However, hydrogen peroxide will decompose in the presence of an alkaline into hydrogen ion (H⁺) and perhydroxyl (OOH⁻) ion. The bleaching with the use of hydrogen peroxide in the alkaline environment is often regarded to be due to increased perhydroxyl ion content in the system which in turn is due to peroxide disassociation and its equilibriation with the alkaline hydroxide.

Preferably, the alkaline environment can be achieved by using an aqueous ammonia solution as an alkaline solution. More preferably, the bleaching agent is formed by blending 80-90 wt % of the aqueous hydrogen peroxide solution and 10-20 wt % of the aqueous ammonia solution based on an overall weight of the bleaching agent. In this embodiment, the bleaching agent is formed by blending 85 wt % of the aqueous hydrogen peroxide solution that contains 27% of hydrogen peroxide based on an overall volume of the aqueous hydrogen peroxide solution with 15 wt % of the aqueous ammonia solution that contains 25% of ammonia based on an overall volume of the aqueous ammonia solution.

The red oak product is soaked in the bleaching agent in a suitable soaking duration, preferably 15-30 minutes. If the soaking duration is less than 15 minutes, the blenching effect for the red oak product may be insufficient. If the soaking duration is more than 30 minutes, the red oak product may be over-bleached. Furthermore, if the aqueous ammonia solution contains more than 25% of ammonia based on the overall volume of the aqueous ammonia solution or if the amount thereof is more than 15 wt % based on the overall weight of the bleaching agent, the soaking duration of the red oak product in the bleaching agent is required to be shortened. On the other hand, if the aqueous ammonia solution contains less than 25% of ammonia based on the overall volume of the aqueous ammonia solution or if the amount thereof is less than 15 wt % based on the overall weight of the bleaching agent, the soaking duration of the red oak product in the bleaching agent is required to be lengthened.

In the step (c), the red oak product after the step (b) can be dried in any suitable manner well-known in the art. In the preferred embodiment, the red oak product is dried in a drying oven at a temperature ranging from 35 to 45° C.

In the step (d), the coloring agent is formulated by blending a coloring material, an acrylic resin, and a suitable solvent in a weight ratio of 2:1:17. The solvent is used for diluting the acrylic resin, and may be any suitable solvent well-known in the art. The acrylic resin is used for enhancing the adhesion of the coloring material on the red oak product. The coloring material is formulated by blending 80-90 wt % of a first pigment having a color code of M80+B70+Y35 (brownish red series pigment), 3-5 wt % of a second pigment having a color code of M40+B80+Y35 (brownish yellow series pigment), and 7-10 wt % of a third pigment having a color code of M0+B100+Y35 (black series pigment) based on an overall weight of the coloring material.

Additionally, the red oak product after the step (d) is allowed to dry in any suitable manner in the drying step (e) to result in the colored red oak product of this invention.

In the method of this invention, red oak products are bleached and subsequently colored to overcome the problems associated with “black mineral streak” and so that the products are colored according to the specific requirement of the customer. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for forming a colored red oak product, comprising the steps of:
(a) processing a red oak substrate to form a red oak product;
(b) soaking said red oak product in a bleaching agent so as to bleach surfaces of said red oak product;
(c) drying said red oak product after said step (b); and
(d) dyeing said red oak product in a coloring agent after said step (c).

2. The method as claimed in claim 1, further comprising a step of drying said red oak product after said step (d).

3. The method as claimed in claim 1, wherein said red oak product is one selected from the group consisting of a baluster, an armrest, a stair tread, a fitting, and a newel post.

4. The method as claimed in claim 1, wherein said bleaching agent comprises 80-90 wt % of an aqueous hydrogen peroxide solution and 10-20 wt % of an aqueous ammonia solution based on an overall weight of said bleaching agent.

5. The method as claimed in claim 4, wherein said aqueous hydrogen peroxide solution contains 27% of hydrogen peroxide based on an overall volume of said aqueous hydrogen peroxide solution, said aqueous ammonia solution containing 25% of ammonia based on an overall volume of said aqueous ammonia solution.

6. The method as claimed in claim 1, wherein said coloring agent includes a coloring material, an acrylic resin, and a solvent, said coloring material and said acrylic resin being in a weight ratio of 2:1.

7. The method as claimed in claim 6, wherein said coloring material includes 80-90 wt % of a first pigment having a color code of M80+B70+Y35, 3-5 wt % of a second pigment having a color code of M40+B80+Y35, and 7-10 wt % of a third pigment having a color code of M0+B100+Y35 based on an overall weight of said coloring material.

8. A method for forming a colored wood product, comprising the steps of:
(a) processing a wood substrate to form a wood product;
(b) soaking said wood product in a bleaching agent so as to bleach surfaces of said wood product;
(c) drying said wood product after said step (b); and
(d) dyeing said wood product in a coloring agent after said step (c);
wherein said wood product is one selected from the group consisting of a baluster, an armrest, a stair tread, a fitting, and a newel post.

9. The method as claimed in claim 8, further comprising a step of drying said wood product after said step (d).
